(19) United States
(12) Patent Application Publication
(10) Pub. No.: US 2007/0090314 A1
(43) Pub. Date: Apr. 26, 2007

(54) Micromachined knife gate valve for high-flow pressure regulation applications

(76) Inventors: Wouter Van Der Wijngaart, Stockholm (SE); Goran Stemme, Stockholm (SE); Anthony S. Ridgeway, What Cheer, IA (US)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/559,409

(22) PCT Filed: Jun. 7, 2004
(86) PCT No.: PCT/IB04/50854

§ 371 Date: Dec. 5, 2005

(30) Foreign Application Priority Data
Jun. 6, 2003 (SE) 0301637-5

(51) Int. Cl. F16K 31/02; F16K 31/06

(52) U.S. Cl. 251/11; 251/129.06; 251/129.01; 137/596.17

(57) ABSTRACT

The present invention discloses a microvalve for providing pneumatic-flow regulation suitable for use in microsystem applications that are operable using highly efficient actuation means for flow obstruction while being space efficient in design in a manner that is suitable for cost effective bullsk microfabrication. In an embodiment of the invention, the microvalve comprises a first substrate layer, a second layer disposed over the first substrate layer cooperating with the first substrate layer to form a channel through which the flow traverses and defines a direction of the flow. An obstruction element or knife gate is micromachined into the second layer such that it is pivotably attached and actuated with a bimorph actuator to displace the gate along a plane that is substantially perpendicular to the direction of the flow in order to controllably regulate the flow. In a further embodiment, a microsystem comprising the microvalve concept of the invention is microfabricated into an IP-converter for pneumatic high flow pressure control applications.

### FIELD OF THE INVENTION

The present invention relates generally to microfabricated electro-pneumatic valves and Microsystems, and more particularly, to an improved microvalve design using footprint efficient layouts that are suitable for bulk microfabrication and for lower cost production.

### BACKGROUND OF THE INVENTION

Interest in Microsystems has increased in recent years because of their potential to reduce system fabrication cost through batch processing, physical size reduction, improved end-product quality, and enhanced performance, for example. Silicon based Microsystems allow mass replication of systems and manufacturing into tiny packages at relatively low costs using conventional IC fabrication techniques. These microfabrication techniques enable a large number of devices to be made on a single silicon wafer thereby significantly driving down production costs when compared to techniques used in the past. Furthermore, advances in plastic microreplication techniques have enabled further cost reductions to be realized in polymer microsystems.

Microsystems comprise microfluidic devices such as microfabricated microvalves for fluid control, which are used in a wide variety of applications. Microactuators, such as microvalves, micropumps, and microsensors, utilizing e.g. mechanical and optical sensing principles, can be used for industrial applications as well as medical applications. Active microvalve devices are devices that typically include flow ducts between a fluidic inlet and a fluidic outlet such that fluid flow is controlled from inlet to outlet by way of transducing a control signal into a change in the pressure-flow characteristics of the flow duct.

One area of industry that holds potential for the introduction of Microsystems is S that of pressure regulation and control. Pressure controllers (also called E/P-converters or I/P-converters, where E stands for electrical, I for current and P for pressure), are basic elements in a vast number of industrial applications. Their basic function is to convert an electrical control signal into a work pressure P_{work}. As such, they form the interface between electronic control signals and pneumatic control elements in larger industrial systems.

Current conventional standard pneumatic components are relatively bulky and too expensive for many applications. Microsystem pressure controller devices could benefit from the cost advantages of microfabrication if operating performance can be maintained in terms of pressure and flow characteristics. Efforts have been made in the past to develop microvalves for pneumatic systems, however, most do not meet the demands of industrial use, both technically and economically. To enable the integration in sub-systems like pneumatic cylinders, the outer dimensions of the pneumatic components have to be as small as possible. Ideally, the form factor should be compatible with standard pneumatics, where the width of the valves is standardized and 10 mm is the smallest standard at present. General requirements include a high air flow, a low leak rate, a short response time, a wide temperature range, the ability to adapt unclean environments, and having to operate in standard pressure ranges of e.g. 0 to 8 Bar and requiring as low as possible power consumption. A reason for the low flow/pressure performance-per-cost of most current miniaturisation trials has been a primarily technical issue. By way of example, a popular microvalve type is the so-called seat valve.

FIG. 1 shows an exemplary seat type microvalve of the prior art. The microvalve operates by utilizing an out-of-plane moving boss or diaphragm 100 that regulates the flow through an in-plane orifice 110, the latter being surrounded with a valve seat 120 that affects a viable seal. The actuation of the boss element can be achieved through a number of techniques such as piezoelectric, electrostatic, pneumatic magnetic, or thermal actuation means that e.g. use dissimilar metals with differing coefficients of thermal expansion that deform to produce actuator movement. The limited force and/or stroke of the microactuator severely limit the pressure and flow performance due to the inherent restriction of the small flow ducts. Moreover, the static pneumatic force acts to counteract the valve actuation. To obtain a large flow rate and a high-pressure control performance with such valves, the device footprint area must be increased accordingly. This decreases the device count per batch and thus increases manufacturing costs. Detailed investigations of these effects are published by the department of Signals, Sensors and Systems (KTH-S3), Royal Institute of Technology, Stoclcholm, Sweden. Moreover, a second failure mechanism has been observed, particle sensitivity, which is a direct result of the low stroke and the large seat length of these types of valves.

Micromachined actuators have been included in many microsystem designs, including microvalves. However, in the past either the actuator's stroke length or the force delivered by the actuator is typically limited. These effects place a limitation on the performance of the majority of microvalve designs i.e. where the actuator directly controls the movement of a boss. A small stroke length constitutes a high flow restriction between the boss and the valve seat, limiting the flow the valve can control. A large stroke length, on the other hand, limits the actuation force, and thus the pneumatic pressure that the valve can control. Furthermore, an increase in the actuator size to improve performance is space consuming and results in higher manufacturing costs, which is undesirable.

A problem that conventional seat type valves must inherently contend with is flow resistance. Flow resistance can be seen as an obstruction in a flow channel or at a flow nozzle. Thus, one of the main problems in microvalve design is to provide a flow obstruction that can sufficiently counteract the pneumatic forces of the flow it controls. Hence, conventional seat type valves require relatively high actuation forces to operate.

Another issue that arises with operating at the micro level scale is that miniaturization of components has specific consequences. The scaling down with a factor N, results in a downscaling of masses and volumes with N³ and of areas with N². This means that surface tension effects and tribological effects dominate in Microsystems. For this reason it is virtually impossible to use sliding contacting structures at the micro level scale. Therefore, moving structures need to be “free-hanging” to avoid any type of friction.

U.S. Pat. No. 6,592,098 describes a microvalve using a valve seat and diaphragm that is actuated to turn on and “pinch” off the flow. To suitably operate the valve, the diaphragm requires biasing in order to maintain sufficient pressure to operate the valve. Moreover, the diaphragm area lies in the plane of the substrate thus imposing an inherent limit on how much the footprint area of the device can be reduced, thereby preventing significant increases in the number of devices that can be microfabricated on a silicon wafer that would reduce costs.

In view of the foregoing, it is desirable to provide a microvalve design for use in microsystems that mitigates the aforementioned disadvantages. The design of which can provide high operating efficiency by using low energy actuation that is cost effective by using space efficient layouts that are especially conducive to high volume microfabrication.

### SUMMARY OF THE INVENTION

Briefly described and in accordance with embodiments and related features of the invention, there is provided a microvalve for providing flow regulation within a microsystem application that uses highly efficient actuation while providing a space efficient layout in a manner that is suitable for cost effective bulk microfabrication In an embodiment of the invention, the microvalve comprises a first substrate layer, a second layer disposed over the first substrate layer cooperating with the first substrate layer to form a flow duct through which the flow traverses and defines a direction of the flow. An obstruction element or knife gate is micromachined into the second layer such that it is attached to the second layer and actuated by a bimorph actuator to displace the gate along a plane that is substantially perpendicular to the direction of the flow and out of plane with respect to the first substrate layer in order to regulate the flow. Moreover, the microvalve of the invention can be actuated by means that include thermal, pneumatic, piezoelectric, electrostatic, and magnetic means. The cross-sectional area of the flow duct is perpendicular to the plane of the substrate that allows the footprint area (FPA) of the device to be reduced substantially since it is independent from the cross-sectional area of the flow duct.

In another embodiment of the invention, a microsystem comprising the microvalve concept of the invention is microfabricated into an IP-converter that can be used in pneumatic high flow/pressure control applications. The microsystem comprises at least three pneumatic ports that includes a supply port, a work port and a vent port whereby the three ports are coupled respectively to a supply pressure (P_{supply}), a work pressure (P_{work}), and a vent pressure (Pᵥₑₙₜ). The microsystem comprises first knife gate microvalve, which is pneumatically coupled to the supply port and the work port for regulating the flow between supply pressure (P_{supply}) and the work pressure (P_{work}). Moreover, a second knife gate microvalve is pneumatically coupled to the work port and the vent port for regulating the flow between the work pressure (P_{work}) and the vent pressure (Pᵥₑₙₜ). The pneumatic flow within the microsystem is regulated using control signal means that are electrically coupled to the microvalves that selectively actuate the microvalves.

In a method aspect of the invention, a method of operating a microvalve to provide flow regulation of a fluid is described. The microvalve comprises a first substrate layer, a second layer disposed over the first substrate layer and cooperating with the first substrate layer to form a channel through which a main flow traverses and defining a direction of flow. An obstruction element or gate formed from the second layer is connected to a member that is attached to the second layer. An actuator is operative on the obstruction element for displacing the obstruction element along a plane that is substantially perpendicular to the direction of the main flow and out of plane with respect to the first substrate layer.

### BRIEF DESCRIPTION OF THE DRAWINGS

The invention, together with further objectives and advantages thereof, may best be understood by reference to the following description taken in conjunction with the accompanying drawings in which:

FIG. 1 shows an exemplary seat type microvalve of the prior art;

FIG. 2 schematically shows an exemplary frictionless “free-hanging” microvalve gate structure;

FIG. 3 shows direction axes with respect to the plane of a silicon wafer;

FIGS. 4a illustrates a design depicting a flow direction that is out-of-plane with respect to the substrate and an obstruction element moving in an in-plane direction;

FIGS. 4b illustrates a design with an in-plane direction for the flow direction and the obstruction element movement;

FIGS. 4c illustrates a design with an in-plane flow direction and out-of-plane obstruction element movement in accordance with the invention;

FIG. 5 illustrates an exemplary knife gate microvalve in accordance with an embodiment of the invention;

FIG. 6a illustrates a microvalve design showing a pressure recovery area that reduces generated forces that counteract the operation of the gate assembly;

FIG. 6b shows a top view of an exemplary side gate microvalve having a reduced footprint area in accordance with an embodiment of the invention;

FIGS. 6c-6e show side, top, and end view illustrations of microvalves operating in accordance with the invention;

FIG. 7 shows the exemplary processing steps used to fabricate the microvalve structure of an embodiment of the invention;

FIG. 8 shows a schematic of an exemplary IP-converter microsystem;

FIGS. 9a-9b are diagrammatic illustrations of the microvalves used in the microsystem and the associated packaging in accordance with an embodiment of the invention.

FIG. 10 illustrates a microvalve arrangement using separate actuators for opening and closing the valve in accordance with an embodiment of the invention; and

FIG. 11 shows a perspective view of a fabricated IP-converter microsystem device in accordance with an embodiment of the invention.

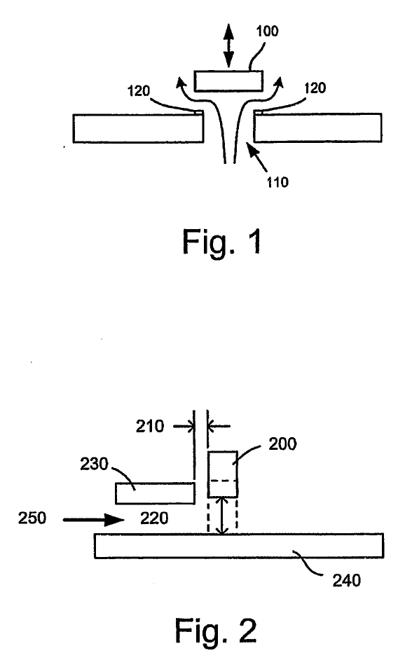

### DETAILED DESCRIPTION OF THE INVENTION

FIG. 2 schematically shows an exemplary microvalve structure where, in accordance with the principles of the present invention, the amount of energy required to operate the obstruction element is reduced by introducing a frictionless “free hanging” flow obstruction element 200 that moves in a plane that is substantially perpendicular to the direction of the fluid flow 250. In this configuration, a small flow leakage gap 210 exists between the obstruction element 200 and a section of the second layer 230 that is formed when the second layer is disposed above substrate layer 240. Although the existence of the gap 210 will inherently allow some of the flow to leak through when the valve is in the closed state, there are however, various design techniques available that can implemented to reduce the leakage flow.

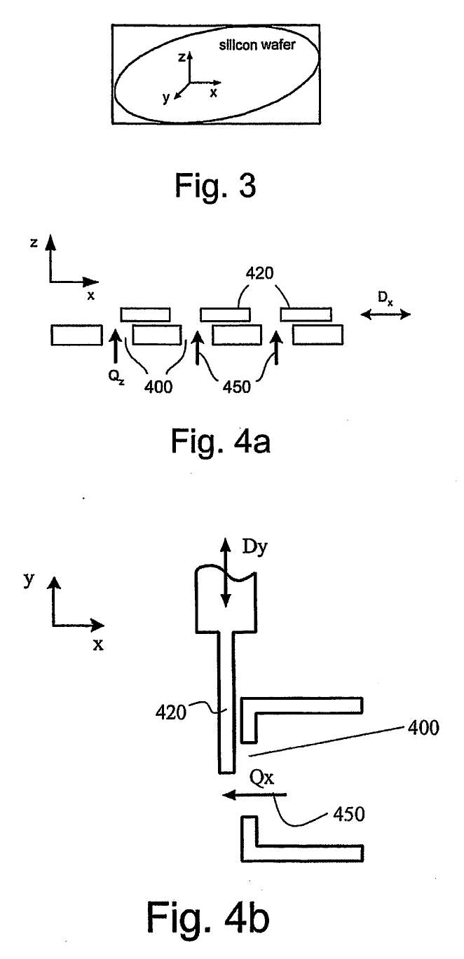

FIG. 3 shows direction axes with respect to the plane of a silicon wafer. The axes define planar relationships that illustrate three basic configurations for keeping the flow and the obstruction movement perpendicular to one another in micromachined microvalve structures. The x and y axes lay in the plane of the wafer and are perpendicular to one another. The z-axis defines a direction perpendicular to the wafer plane.

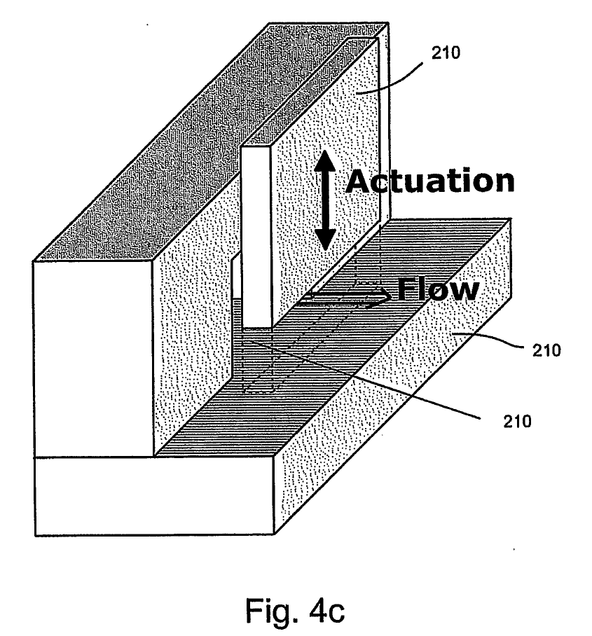

FIG. 4a illustrates a first design that has been used to show a cross-sectional view of a microvalve assembly where the gas flow Q_{z} 450 is out-of-plane with respect to the wafer and the obstruction movement Dₓ in-plane with respect to the wafer surface. In this design, one or more orifices 400 can be closed with a sliding obstruction plate 420. Here several nozzles are used in parallel in order to reduce the obstruction stroke length Dₓ. Preferably, the actuation means comprise thermal actuation and electrostatic comb drive means. An exemplary fabrication technique that can be used with this design is Deep Reactive Ion Etching (DRIE) and wafer-through inlet etching using a 2-wafer stack.

FIG. 4b illustrates top view of a second design by which the gas flow Qₓ 450 is in-plane with respect to the wafer and the obstruction 420 movement D_{y} is also in-plane with the wafer but is also perpendicular to the gas flow 450. The actuation means preferably can use thermal actuation and electrostatic comb drive actuation. A technique that works well for fabricating this design is DRIE using a 2-wafer stack.

FIG. 4c illustrates a perspective view of a third design where the gas flow Q_{y} is in-plane with the wafer and the obstruction 200 movement D_{z} out-of-plane. Here, the actuation methods that work well include thermal, magnetic, electrostatic, pneumatic or piezoelectric actuation, where the fabrication can be performed with the DRIE method using a 2-wafer stack. This configuration is often referred to as a knife gate microvalve, which exhibit the principles outlined in the present invention.

In accordance with an embodiment of the invention, there is provided a flow control knife gate microvalve suitable for replacing large-scale valves. The device of the present invention, also referred to as a knife gate microvalve, features an increased flow-pressure performance per device footprint area and overcomes the drawbacks of the microvalves described in the prior art.

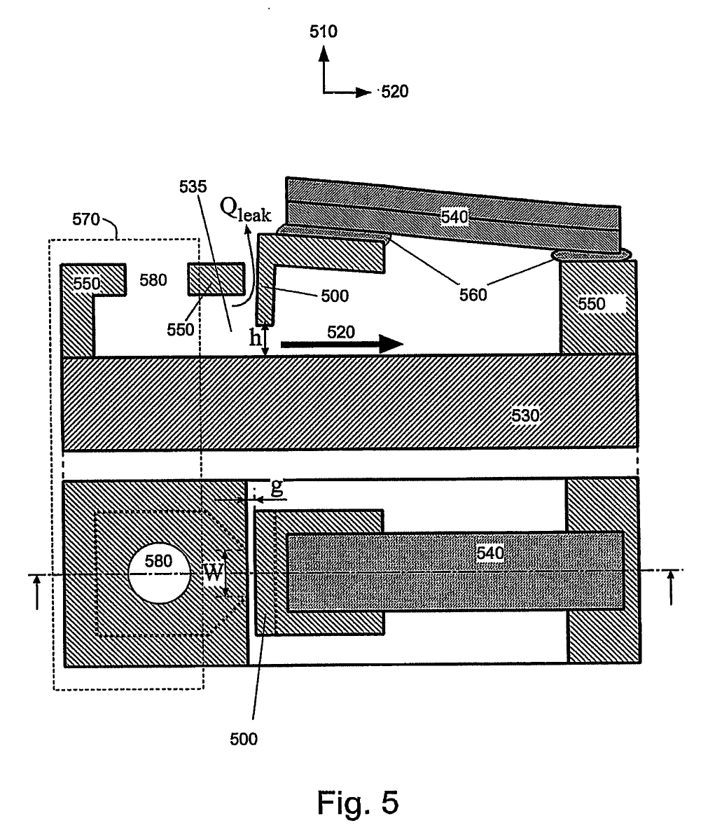

FIG. 5 illustrates an exemplary knife gate pneumatic microvalve that is operable for providing flow and pressure regulation in accordance with the embodiment of the invention. In the embodiment, the obstruction is a valve gate 500 that moves along an axis 510 that is perpendicular to the flow direction 520 and the static pneumatic force (hence it is also referred to as a cross-flow valve or X-Valve). In this configuration, the static pressure and valve actuation do not counteract one another, thereby reducing the required actuator force and size. Moreover, the X-Valve features a gas flow direction 520 that is in-plane (with respect to substrate 530) and a gate displacement that is out-of-plane with respect to the substrate 530. Unlike prior art microvalves, the orifice area at the fluid duct 535 is perpendicular to the wafer plane, as opposed to lying within the plane of the wafer, thereby allowing the footprint area consumed by the device to be independent of the orifice area and thus flow performance. This allows the knife gate microvalve to control a larger flow and higher pressure with a more compact design.

The gate element 500 is pivotally attached to the second layer of silicon 550 via a piezo bimorph actuator arm 540 with glue at points 560. The movement from the pivot enables sufficient vertical displacement h to be achieved in order to block the flow, or allow it to pass unobstructed. It should be noted that other methods than glue to attach the gate can be used such as soldering, for example. The operation of the knife gate microvalve requires that some spacing be left between the gate 500 and the orifice of the flow duct 535 to avoid friction, which means that a small leakage flow Qₗₑₐₖ will exist in the closed state. Fortunately, however, small leakage flows Qₗₑₐₖ can be tolerated in many flow and pressure controller applications.

The actuator means in the embodiment preferably uses a piezoelectric bimorph actuator 540 for displacing gate 500. A flow duct extension indicated within dashed line 570 extends the flow duct length 535 and is pneumatically coupled to the device package via an opening 580 that lies in the plane of the second layer. It should be noted that various thermal actuation means such as bimorph actuation, shape memory alloy, or thermopneumatic means could be used to actuate the gates.

The knife gate microvalve microstructure of the embodiment is fabricated in silicon and etched using, for example, Deep Reactive Ion Etching (DRIE). The microfabrication process involves silicon fusion bonding and bulk micromachining, which is a subtractive fabrication procedure where the substrate is used to produce the primary mechanical structures. It should be noted that other techniques can be used such as surface micromachining where thin layers of film are deposited on the surface of the substrate such that the layers are then used as mechanical structures. However, the DRIE etching technique performs particularly well for etching of high aspect ratio features such as narrow and deep grooves, for example.

There are a number of specific challenges to consider in order to optimize batch fabrication of the microvalves. First, the design must be footprint-efficient, as footprint area is one of the primary cost driving factors for the device. The second involves providing reliable and reproducible fabrication of the high-aspect ratio spacing gap between the valve gates and their respective orifices. This gap determines the closed-state leakage flow rate of the microvalve. The microfabrication processes, especially when using DRIE, can be tuned for this feature, In one embodiment of the invention, the closed-state leakage flow can be substantially diminished or even eliminated using an appropriate valve design. By way of example, once the obstruction element is in the closed position it can then be moved laterally against the main flow direction, thereby reducing the gap. By way of example, the “free-hanging” gate or obstruction element, when in a closed position, can be moved laterally a small distance, in a direction substantially parallel to the direction of the direction of the flow, against a jam formed from the second layer. This acts to reduce or block off any leakage flow that would previously escape between the gate and the jam. By way of example, the additional lateral movement of the obstruction element could be effected using, for example, cooperative electrostatic actuation means arranged to induce movement of the obstruction element suitable to block the leakage. Thirdly, the actuator needs to be optimized in terms of power dissipation versus actuator stroke length. Preferably, the system can be actuated with the electrical power delivered via a standard electrical communication bus.

To maintain system controllability may require further design optimization, for example, the existence of hysteresis in the signal-gate stroke relation can be expected. This results from the Bernoulli suction and pressure recovery that occurs in the compressible flow in the structure causing a risk of undesired pneumatic forces on the bimorph actuator or even mechanical instability. Also, thermal cooling of the bimorph actuator due to the gas flow might influence the system controllability by preventing the gate from opening and closing properly. Such effects can be successfully addressed by those skilled in the art using appropriate well-known system design techniques.

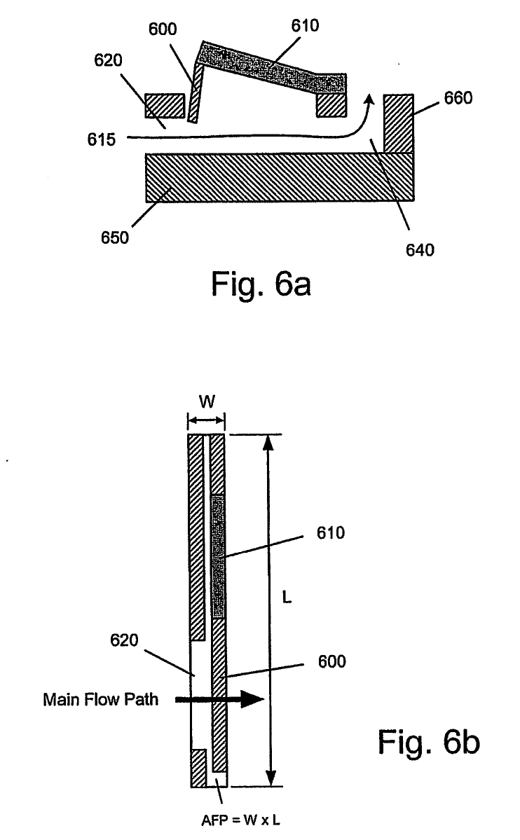

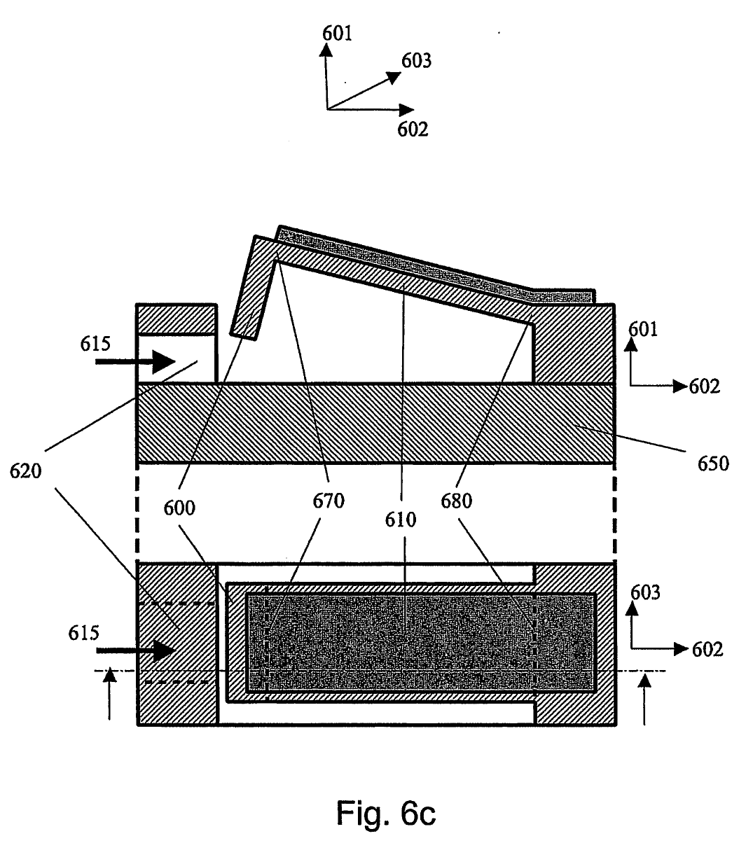

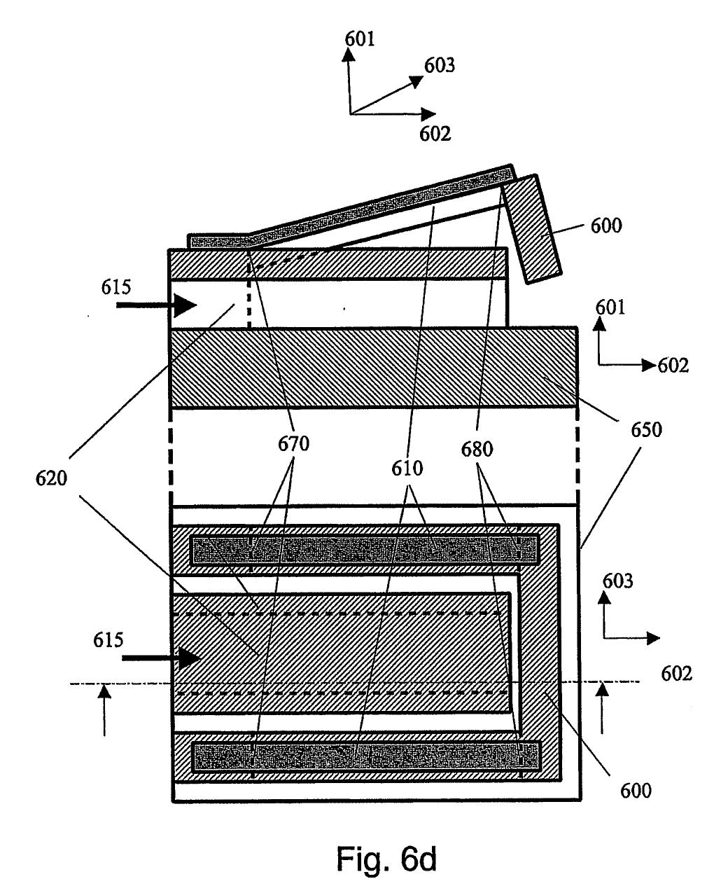

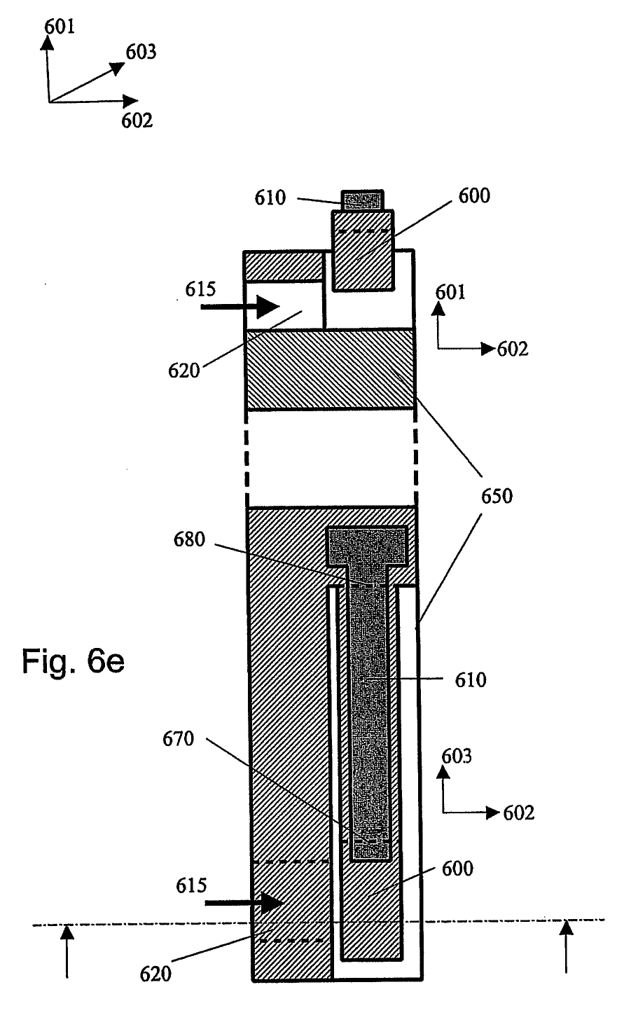

FIG. 6a shows a design technique used in some embodiments that show the main flow 615 traversing the flow duct 620 in the plane of the substrate 650 such that the main flow flows into a pressure recovery area 640 that is located far enough from the gate apparatus so as not to affect its operation. This means that the flow is redirected by a barrier 660 at a location sufficiently distant from the gate assembly, i.e. the obstruction 600 and actuating member 610, such that the static pressure build-up resulting from the pressure recovery will not be near enough to counteract displacement of the gate 600, which moves substantially perpendicular to the main flow 615 and out-of-plane with respect to substrate 650.

With regard to the embodiment, thermal actuation can be used. In-plane thermal actuation exploits the fact that a material expands when heated, as described earlier. In general, thermal actuators tend to exhibit the disadvantage of being relatively slow and slightly more energy consuming than some of the other methods of actuation. Other actuation principles that can possibly used for in-plane fabrication are piezoelectric and magnetic actuation, for example.

The microvalve structures contemplated in the present invention are suitable for use in, among other things, pressure control applications. The design is a key element in a truly miniaturized micro-machined high-performance pneumatic control device. The structure is enhanced with bulk microfabrication using DRIE and silicon fusion bonding. In a further embodiment, the structure is actuated with a glued piezoelectric bimorph gate (500, 540, 560). Flow-pressure tests and flow-gate opening performance measurements were conducted that show very good operating performance with this arrangement. Moreover, it has been shown that the valve flow can be controlled gradually through the gate position with relatively good precision. The fabrication of bulk micromachined pressure controllers with integrated thermoelectric bimorph actuators on silicon wafers allow for a significant improvement in space-efficiency and thereby overall cost.

FIGS. 6c-6e show side, top, and end view illustrations of several possibilities in the relative positioning of the obstruction 600 and the member/actuator 610 that connect the obstruction 600 with the second layer. In the figures, 601 indicates a direction perpendicular to the plane of the substrate, and 602 and 603 indicate perpendicular in-plane directions. Direction 602 is the direction of the main flow 615. The relative positioning of the obstruction 600 and the member/actuator 610 may be of importance when considering the required mechanical strength of the member 610.

In the preferred embodiments, member/actuator 610 is designed to be flexible in direction 601 in order to diminish the required actuation force. This flexibility can be accomplished by having the member/actuator 610 relatively thin in direction 601. At the same time, member/actuator 610 is preferably designed to be relatively stiff in the directions 602 and 603 in order to prevent the movement of the obstruction 600 in those directions. This is normally accomplished by designing the member/actuator to be relatively wide in directions 602 and 603. However, in order to reduce the footprint area required by the member, it is preferable to limit the width of the member/actuator 610 in either one of directions 602 or 603. In the preferred embodiment, there must exist a good compromise between the mechanical strength of the member/actuator 610 and the footprint area consumed by the member/actuator 610.

FIG. 6c illustrates a preferred embodiment in which member 610 lays substantially parallel to the direction 602 of the main flow 615 and moves substantially in a plane defined by the directions 601 and 602. The member-gate attachment point 670 lays up-stream from the member fixture point 680 such that a pivotal movement of the member around fixture point 680 will move the obstruction 600 upwards (direction 601) and slightly in the direction 602 of the main flow 615. This design is mechanically robust because the member 610 can be relatively thin in the direction 603 since there are no substantial pneumatic forces acting on the member in this direction.

FIG. 6d illustrates a preferred embodiment in which two members 610 lay substantially parallel to the direction 602 of the main flow 615 and move substantially in a plane defined by the directions 601 and 602. The member-gate attachment point 670 lays down-stream from the member fixture points 680 such that a pivotal movement of the members around fixture points 680 will move the obstruction 600 upwards (direction 601) and slightly in the opposite direction of the main flow 615. This design is mechanically robust because the members 610 can be relatively thin in the direction 603 since there are no substantial pneumatic forces acting on the members in this direction.

FIG. 6e illustrates a preferred embodiment in which the members 610 lie substantially in the direction 603, perpendicular to the direction 602 of the main flow 615 and moves substantially in a plane defined by the directions 601 and 603. As mentioned earlier, footprint area efficiency is of key interest. An example of a very footprint area efficient microvalve is a so-called side-gate knife gate microvalve.

FIGS. 6b and 6e show views that illustrate the footprint area of an exemplary side gate microvalve in accordance with a further embodiment of the invention. In this configuration, the microvalve comprises an obstruction element or gate 600 that is displaced out of plane with respect to the substrate by actuator means 610. The minimal flow-path cross-sectional area is formed by a flow duct 620, which is the area that determines the amount of flow that can flow through the valve. The flow duct does not put a limit to the footprint miniaturization, since the valves width W can be reduced without limiting the flow duct cross-sectional area. This is because the width W of the structure is perpendicular to the flow duct cross-sectional area. With the reduction in the width W, it can be seen that the footprint area (AFP) is correspondingly reduced, since AFP=L×W.

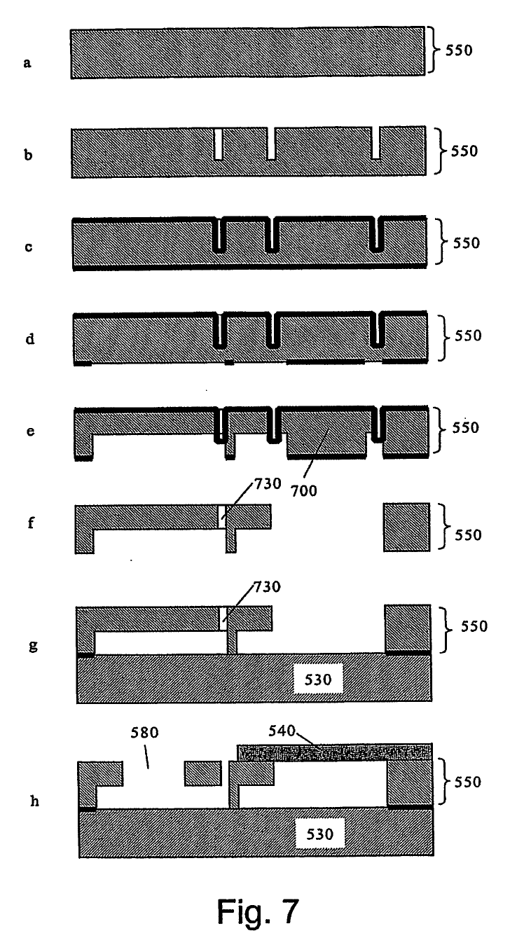

FIG. 7 shows the exemplary processing steps used to fabricate the knife gate structure in accordance with the DRIE microfabrication technique for use with the embodiment. To start, an example using a 200 μm thick double side-polished silicon wafer (FIG. 7a) is spin coated with resist and patterned. The front-side of the device is DRIE etched to a depth of 130 μm (FIG. 7b). The resist is then removed using oxygen plasma. Next, 1 μm thick thermal oxide is grown (FIG. 7c). The backside is patterned and DRIE etched to a depth of hₘₐₓ=70 μm defining the maximum gate opening (FIGS. 7d,e). The resist is again stripped using oxygen plasma and the oxide is removed using a buffered HF solution releasing a fallout structure 700 (FIG. 7f). The 200 μm machined wafer 550 is silicon fusion bonded with a 500 μm single-side-polished wafer 530 (FIG. 7g). After drilling an inlet opening 580, a fluid connector is attached as well as a piezoelectric bimorph actuator 540 using a two-part adhesive epoxy. The member structure 730 that supports the knife gate during manufacturing is now removed by breaking away (FIG. 7h). Note that the use of fall-out structures 700 and the opening of the fluid connector 580 with a mechanical drill were chosen in this fabrication scheme to minimize the exposed silicon area during the first DRIE step and thus optimize the etch quality. It should be noted that the invention is not limited the dimensions given which are merely exemplary for the purpose of illustration. The actual dimensions of a microfabricated device may differ significantly from the exemplary figures,

The knife gate microvalves of the present invention can be used in various microsystem applications while retaining the benefits described herein. An application where using the microvalves of the invention is particularly advantageous is that of an IP-converter.

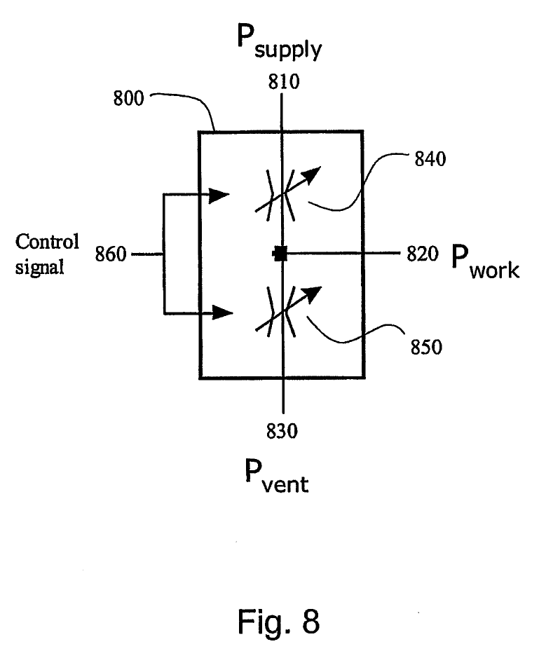

Referring now to FIG. 8, there is shown schematically the basic design of a current (or voltage) to pneumatic (pressure) or the so-called IP converter microsystem 800. The IP converter described in the invention uses a pair of knife gate microvalves (X-Valves) 840, 850 as described above. The work-space of the IP converter is coupled to the supply pressure and vent (e.g. atmosphere) through controllable flow microvalves 840 and 850. Either one or both flow valves 840, 850 can be regulated. By switching between the states of the two valves 840 and 850, the pressure at the work port 820 can be switched between supply pressure at the supply port 810 and the (ambient) vent pressure at the vent port 830, which enables pneumatic work to be performed at the work port 820.

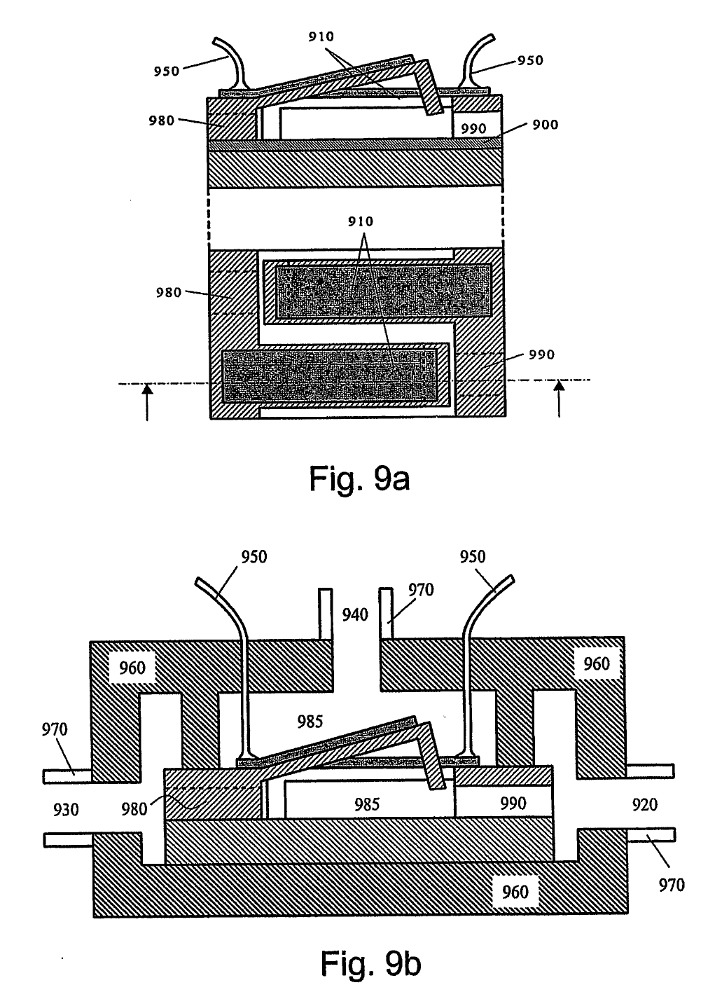

FIG. 9a shows the actuation of the microvalves is provided by cantilevered thermal bimorphs 910, where one X-Valve provides flow regulation at the supply fluid duct 990 and a second X-Valve provides flow regulation at the vent fluid duct 980. The work area 985 guides the work flow. When the control signal closes the supply port and opens the vent port, the work area 985 is evacuated. When the control signal opens the supply port fully open and closes the vent port the maximum work pressure is generated in the work area 985 and at the work port 940. The two X-Valves can be actuated either together or independently to achieve the work flow required. Electrical connections are included to provide the control signal to the actuators 910 through contacts 950. In the embodiment shown in FIG. 9a, a layer of glue 900 is used to bond the substrate with the second layer.

FIG. 9b illustrates a package 960 around the micromachined chip containing the microvalves. The supply port 920, vent port 930 and work port 940 are integrated within the package 960 whereby coupling means 970 are formed as part of the package for connecting to external fluid ducts. The supply port 920 is connected with the supply fluid duct 990 in a pneumatically sealed fashion. The vent port 930 is connected with the vent fluid duct 980 in a pneumatically sealed fashion. Furthermore, the work area 985 is connected with the vent port 940 in a pneumatically sealed fashion.

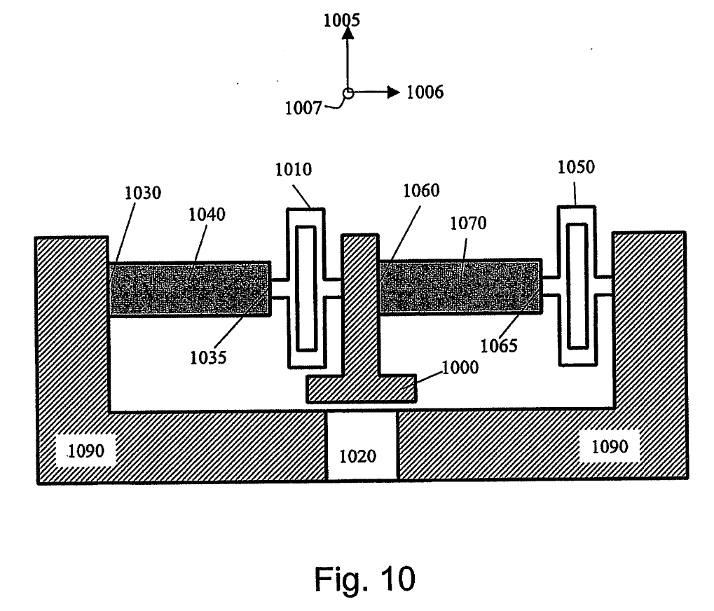

FIG. 10 illustrates a single gate valve embodiment in accordance with the invention in which the gate 1000 can be actively opened and closed using two identical bimorph actuators 1040 and 1070. Bimorph 1040 is attached at one end to the second layer 1090 at point 1030 in a clamped fashion whereby the other end of the bimorph 1040 is attached to the gate 1000 via a spring element 1010. Bimorph 1070 is attached at one end to the gate 1000 at point 1060 in a clamped fashion and is attached at the other end to the second layer 1090 via a spring element 1050. The spring elements 1050 and 1010 are shaped in a manner that allow them to function as a hinge element for rotations around an axis in the direction 1005, and at the same time, allows them to elongate in direction 1006. The bimorph actuators 1040 and 1070 will curve in the same direction when they are heated. However, heating bimorph 1040 will result in a gate displacement that is opposite to the gate displacement obtained when heating bimorph 1070. Thus, two identical bimorphs can be used for the actuators, which are fabricated in the same process but are implemented in the embodiment in a way that enables displacement of the gate in two different directions.

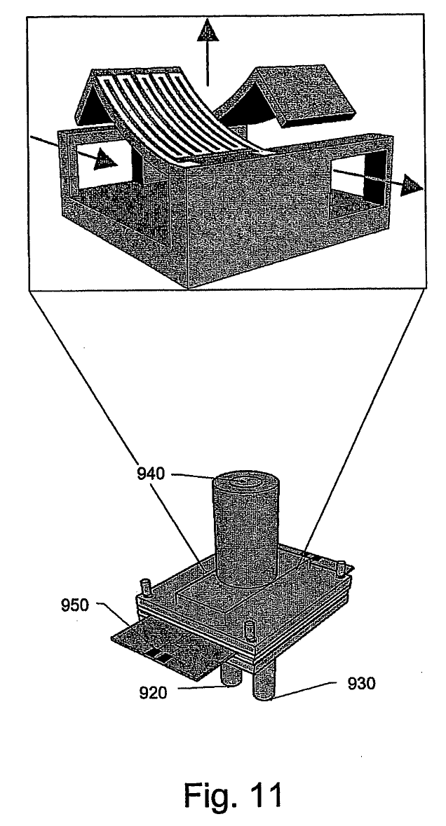

FIG. 11 shows a perspective view of a fabricated IP-converter microsystem device in accordance with the embodiment of the invention. The microvalves are bulk microfabricated on the silicon wafer in which the microvalve units are cut out. The micromachined device is pneumatically sealed by outer packaging to maintain a hermetic seal around the device. The packaging includes a supply port 920 for connection to external pneumatic tubes for the supply flow, a work port 940, and a vent port 930. The package design of the IP converter can affect the overall efficiency of the device, where significant improvements in the efficiency of the microsystem can be achieved through suitable package design.

In IP converters, the spacing gap between the valve gates and their respective orifices determines the pressure range that can be controlled as well as the contribution to the total pneumatic energy losses of the system. Theoretical studies have shown that even a relatively large leak flow does not significantly hinder a large work pressure range. However, to avoid overall pneumatic energy loss, leakage should be minimized and effectively controlled to the greatest extent possible.

When using knife gate microvalves of the type described, the flow leakage of the valves influences the IP-controller's static pneumatic energy loss and reduces the dynamic pressure range of the device, which can be seen in the following equation:
ΔP_{dyn}=Pₘₐₓ−Pₘᵢₙ<P_{supply}=P_{supply}−Pₐₜₘ
and,
P_{supply}>Pₘₐₓ>P_{work}>Pₘᵢₙ>Pᵥₑₙₜ

For flow rates and for device dimensions of interest, frictional losses in the leakage gap are negligible. This is because the low ratio of the gate-orifice spacing (g) over leakage path length and the smoothness of the micromachined surface of the leakage path. Although at high Mach numbers frictional losses do still occur, however, this causes a decrease in the leakage rate, which is beneficial.

Both the main flow and leakage flow can be modeled as isentropic compressible flow in a sudden expansion, in which the mass-flow is described by:

$$n \dot{Y} ∝ {A}_{cs} {{P}_{supply} ( \frac{{P}_{atm}}{{P}_{supply}} )}^{1 / γ} \sqrt{{( \frac{{P}_{supply}}{{P}_{atm}} )}^{1 - 1 / γ} - 1} \qquad ( 1 )$$

with A_{cs} being the minimal cross-sectional area of the flow path and γ the gas specific heat ratio [8,9]. The leak rate can then be quantified as:

$$η = \frac{n {\dot{Y}}_{leak}}{n {\dot{Y}}_{max}} = \frac{{A}_{cs\_leak}}{{A}_{cs\_max}} = \frac{( 2 {h}_{max} + w ) \cdot g}{{h}_{max} \cdot w} \approx \frac{g}{{h}_{max}} \qquad ( 2 )$$

for w>>hₘₐₓ, with hₘₐₓ the maximum gate opening, w the nozzle width, and the indices leak and max referring to the conditions and dimensions at the gate-nozzle spacing and the maximum nozzle opening, respectively.

For a pressure controller comprising two identical control valves with leak rate η, Pₘₐₓ and Pₘₐₓ can be calculated using the mass flow continuity equation:
η\dot{Y}_{supply}=η\dot{Y}_{work}+η\dot{Y}ₗₑₐₖ=η\dot{Y}ₐₜₘ (3)
at zero work flow. P_{work}=Pₘᵢₙ if the vent port is open and the supply port is closed, in which case A_{cs}_{_{—}}_{supply}=ηA_{cs}_{_{—}}ᵥₑₙₜ, respectively P_{work}=Pₘₐₓ if the vent port is closed and the supply port is open, in which case A_{cs}_{_{—}}_{supply}=ηA_{cs}_{_{—}}_{supply}. Pₘᵢₙ and Pₘₐₓ can thus be calculated as the respective solutions of the equations:

$$\begin{matrix}η \cdot {{P}_{supply} ( \frac{{P}_{min}}{{P}_{supply}} )}^{1 / γ} \sqrt{{( \frac{{P}_{supply}}{{P}_{atm}} )}^{1 - 1 / γ} - 1} = {{P}_{min} ( \frac{{P}_{atm}}{{P}_{min}} )}^{1 / γ} \sqrt{{( \frac{{P}_{min}}{{P}_{atm}} )}^{1 - 1 / γ} - 1} \\ & ( 4 ) \\ {{P}_{supply} ( \frac{{P}_{max}}{{P}_{supply}} )}^{1 / γ} \sqrt{{( \frac{{P}_{supply}}{{P}_{max}} )}^{1 - 1 / γ} - 1} = η \cdot {{P}_{max} ( \frac{{P}_{atm}}{{P}_{max}} )}^{1 / γ} \sqrt{{( \frac{{P}_{max}}{{P}_{atm}} )}^{1 - 1 / γ} - 1} & ( 5 )\end{matrix}$$

Graphically solving these equations for 1 bar (relative) supply pressure shows that for a leak rate η=20%, Pₘₐₓ=0.9815 bar and Pₘᵢₙ=0.0376 bar, resulting in a pressure range of

$$\frac{Δ {P}_{dyn}}{Δ {P}_{supply}} \approx 94.4 \% .$$

The two knife gate valves are preferably actuated using a thermal bimorph actuator that is a well-known technique in the art. Power is provided to the contact pads that are in electrical contact with a heater in contact with or integrated with the thermal bimorph actuator. When a current is sent through the heater, the bimorph temperature rises. The temperature change causes the bimorph to bend due to the difference in thermal coefficients of expansion between materials such as aluminum and silicon, for example. It should be noted that other actuation methods might be applicable with the invention such as piezoelectric, magnetic, electrostatic actuation or other thermal actuation principles. In the embodiment, the footprint-efficiency of the device is significantly increased due to the displacement of the gate in a plane perpendicular to the main flow and the main flow path orifice being perpendicular to the substrate (out-of-plane with respect to the substrate) thus eliminating the relatively large orifice as being a factor that negatively affects the footprint area.

The foregoing description of the embodiments of the invention has been presented for purposes of illustration and description. It is not intended to be exhaustive or to limit the invention to the precise forms disclosed, since many modifications or variations thereof are possible in light of the above teaching. Accordingly, it is to be understood that such modifications and variations are believed to fall within the scope of the invention. The embodiments were chosen to explain the principles of the invention and its practical application, thereby enabling those skilled in the art to utilize the invention for the particular use contemplated. It is therefore the intention that the following claims not be given a restrictive interpretation but should be viewed to encompass variations and modifications that are derived from the inventive subject matter disclosed.

1. A microvalve for providing flow regulation suitable for use in a microsystem comprising;
a first substrate layer defining a first plane;
a second layer disposed over the first substrate layer cooperating with the first substrate layer to form a flow duct through which the flow traverses thereby defining a direction of main flow;
an obstruction element defined by the second layer for obstructing the flow, said obstruction element being displaceable in a second plane substantially perpendicular to the direction of main flow and out of plane with respect to the first substrate layer; and
actuator means operative on the obstruction element for controllably displacing the obstruction element to regulate the flow.

2. The microvalve according to claim 1 wherein, the microvalve is a knife gate microvalve whereby the obstruction element is a gate displaceable in the plane substantially perpendicular to the main flow direction for obstructing the flow, and wherein the gate is pivotally attached to the second layer via a member to enable displacement of the gate in a plane that is out of plane with respect to the first substrate layer to obstruct the flow.

3. The microvalve according to any one of claim 1 wherein, the external actuator means is attached to the obstruction element operative for controllably displacing the obstruction element to regulate the flow.

4. The microvalve according to claim 1 wherein, the actuator means is a thermal bimorph actuator comprising materials with different thermal expansion coefficients such as aluminum bonded together with the material from the second layer, wherein a controllable temperature change causes the bimorph actuator to bend due to the difference in thermal coefficients of expansion between the materials.

5. The microvalve according to claim 1 wherein the gate is pivotally attached to the second layer by at least two members comprising thermal bimorph actuators, and wherein the selective actuation of the members displace the gate in opposite directions when actuated such that the microvalve can be actively opened or closed by heating up the actuator means.

6. The microvalve according to claim 1 wherein, the microvalves are actuated using piezoelectric actuation means.

7. The microvalve according to claim 1 wherein, the microvalves are actuated using magnetic means.

8. The microvalve according to claim 1 wherein, the microvalves are actuated using electrostatic means.

9. The microvalve according to claim 1 wherein, the microvalves are actuated using thermal actuation means such as monomorph expansion, shape memory, or thermopneumatic means.

10. The microvalve according to claim 1 wherein, the obstruction element is displaced to obstruct the flow in a frictionless “free-hanging” manner in order to avoid tribological effects during operation.

11. The microvalve according to claim 10 wherein, the “free-hanging” obstruction element, when in a closed position, is laterally moved a small distance in a direction substantially parallel to the direction of the direction of the flow against a jam formed from the second layer to reduce or block off any leakage flow.

12. The microvalve according to claim 1 wherein, the main flow is redirected at a point sufficiently far from the obstruction element and actuator means so that any pressure buildup from the main flow will not create forces that will counteract the operation of the obstruction element.

13. The microvalve according to claim 1 wherein, said second layer mainly comprises silicon material into which the microvalve structures and features are machined into a silicon wafer using bulk micromachining or surface micromachining.

14. The microvalve according to claim 13 wherein, the microvalve structures are microfabricated using Deep Reactive Ion Etching (DRIE).

15. The microvalve according to claim 12 wherein, the said second layer mainly consists of a polymer and which is fabricated using plastic replication.

16. The microvalve according to claim 1 wherein, the cross-sectional area of the flow duct is perpendicular to the plane of the substrate allowing the footprint area (FPA) of the device to be independent from the cross-sectional area of the flow.

17. The microvalve according to claim 16 wherein, the ratio between the flow duct length and the hydraulic diameter of the flow duct is at least less than 10, such that the footprint area (FPA) is minimized.

18. A microsystem for providing electro-pneumatic pressure control, wherein the microsystem having at least three pneumatic ports including a supply port, a work port and a vent port, and wherein the three ports are coupled respectively to a supply pressure (P_{supply}) a work pressure (P_{work}), and a vent pressure (Pᵥₑₙₜ), said microsystem comprising;
a first microvalve pneumatically coupled to the supply port and the work port for regulating the flow between supply port and the work port;
a second microvalve pneumatically coupled to the work port and the vent port for regulating the flow between the work port and the vent port; and
control signal means electrically coupled to the microvalves to control the pneumatic flow within the microvalves by actuating the microvalves.

19. A microsystem according to claim 18 wherein, the microsystem comprises a microvalve for providing flow regulation comprising;
a first substrate layer defining a first plane;
a second layer disposed over the first substrate layer cooperating with the first substrate layer to form a flow duct through which the flow traverses thereby defining a direction of main flow;
an obstruction element defined by the second layer for obstructing the flow, said obstruction element being displaceable in a second plane substantially perpendicular to the direction of main flow and out of plane with respect to the first substrate layer; and
actuator means operative on the obstruction element for controllably displacing the obstruction element to regulate the flow.

20. A microsystem according to claim 18 wherein, the microvalves are actuated using piezoelectric actuation means.

21. A microsystem according to claim 18 wherein, the microvalves are actuated using magnetic means.

22. A microsystem according to claim 18 wherein, the microvalves are actuated using electrostatic means.

23. A microsystem according to claim 18 wherein, said microvalves are microfabricated and manufactured into a pneumatically sealed package connectable to external flow ducts.

24. A method of operating a microvalve to provide flow regulation of a fluid comprising a first substrate layer, a second layer disposed over the first substrate layer cooperating with the first substrate layer to form a channel through which a flow traverses and defining a direction of flow, an obstruction element defined by the second layer for obstructing the flow, and actuator means attached to the obstruction element for displacing the obstruction element, the method comprising the step of displacing the obstruction element along a plane substantially perpendicular to the direction of the flow and out of plane with respect to the first substrate layer.

25. The method according to claim 24 wherein, the displacement of the obstruction element is produced by a thermal actuation means, magnetic means, piezoelectric means or electrostatic means.

26. The method according to claim 24 wherein, the obstruction element can be actuated and displaced in opposite directions in response to a control signal such that the microvalve can be actively opened or closed by heating up the actuator means.
